(19) United States
(12) Patent Application Publication
(10) Pub. No.: US 2019/0352935 A1
(43) Pub. Date: Nov. 21, 2019

(54) SECURITY ZONE BARRICADE DEVICE

(71) Applicant: GEORGE E. COX, BREMEN, IN (US)

(72) Inventor: GEORGE E. COX, BREMEN, IN (US)

(21) Appl. No.: 16/415,276

(22) Filed: May 17, 2019

Related U.S. Application Data
(60) Provisional application No. 62/673,222, filed on May 18, 2018.

(51) Int. Cl. E05B 63/18; E05B 63/00; E05B 15/02; E05B 9/02; E05B 17/20; E05B 17/00; E05C 1/04

(52) U.S. Cl. CPC E05B 63/185; E05B 63/0004; E05B 15/0205; E05Y 2900/132; E05B 17/2049; E05B 17/0045; E05C 1/04; E05B 9/02

(57) ABSTRACT

A retrofit door locking system is for being attached to an existing door. The system has a bolt receiver affixed to the door frame and a mounting plate. The mounting plate has a bolt tube that carries a slidable bolt. The bolt slides inside the tube and can be affixed between a retracted and extended position with a lock or a cotter pin. The bolt can be affixed by a lock that extends into grooves on the bolt or through a cotter pin that extends through a transverse hole. Along with being used to lock the door closed, the door can be prevented from latching by extending the bolt and locking it in the extended position.

### CROSS REFERENCE TO RELATED APPLICATIONS

This application claims the benefit of U.S. Provisional Application No. 62/673,222, filed May 18, 2018, the disclosures of which are hereby incorporated by reference.

### BACKGROUND OF THE INVENTION

This present disclosure relates to safety and security devices. There are many types of deadbolts, locks, catches, and stops that can lock a door. Most of these only contemplate the user's desire to keep intruders out. Classrooms and other locations sometimes dictate that the door must be kept locked or unlocked during certain times or events. Current devices available allow the door to be locked or unlocked but there are no provisions to keep the unauthorized users from locking and unlocking the door. An improved device is needed.

### SUMMARY OF THE INVENTION

The present disclosure describes a door locking device that can be locked in an unlocked state and a locked state. The device is affixed to a door, typically on the inside, and functions to either lock the door securely or to prevent the door from being closed. The lock can be moved between a locked and an unlocked position, and in either position, the lock can be affixed, either with a key or a pin. For example, during a fire drill, the door can be prevented from being closed to allow the fire department to easily do a sweep, particularly in areas where the door will automatically latch and lock from an automatic door closer. The door can be locked securely in the latched position in the event of an active shooter or other security threat. Because the device can be held in the locked position prevents someone from smashing out a window to gain access to the inside handle to open the door.

### BRIEF DESCRIPTION OF THE DRAWINGS

FIG. 1 is an isometric view of the lock as installed;

FIG. 2 is partial section view of the lock as shown in FIG. 1;

FIG. 3 is a front view of the lock in the unlocked position with the bolt movable;

FIG. 4 is a front view of the lock in the unlocked position with the bolt held with a pin;

FIG. 5 is a front view of the lock in the unlocked position with the bolt locked;

FIG. 6 is a front view of the lock in the locked position with the bolt movable;

FIG. 7 is a front view of the lock in the locked position with the bolt held with a pin;

FIG. 8 is a front view of the lock in the locked position with the bolt locked;

FIG. 9 is an exploded isometric view of the lock;

FIG. 10 is a side view of the bolt and receiver in FIG. 9; and

FIG. 11 is a section view 11-11 of the bolt and receiver in FIG. 10.

### DESCRIPTION OF THE PREFERRED EMBODIMENT

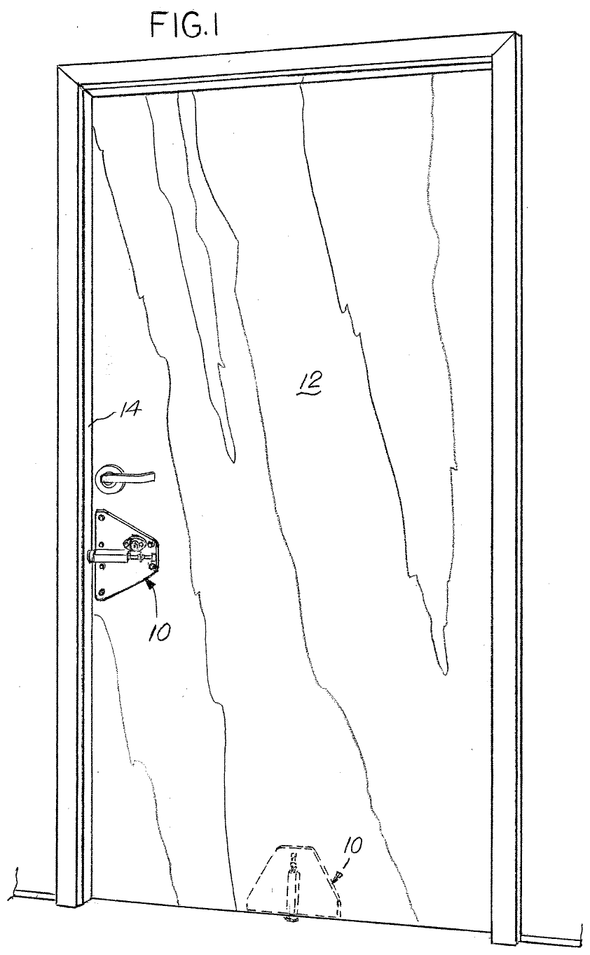

A lock 10 is shown in the FIGS and is designed to be affixed to a door 12 or affixed to the wall or door frame 14 adjacent the door 12. As is well-known in the art, doors pivot on hinges affixed between the door frame 14 and the door 12. When affixed to the door 12, the lock 10 is mounted in a typical location as a normal door latch or lock would be, such as shown in FIG. 1. The lock may also be affixed to the door 12 near the bottom edge to lock it to the floor, as is shown by the lock 10 in hidden lines at the bottom of the door 12 in FIG. 1. This may be necessary if the door swings into the room or if it is adjacent a stairway or when floor access to the lock 10 may be useful. If the lock 10 is affixed to the frame or wall, it would be affixed at a location in the frame near where a door striker plate is affixed. The lock 10, as shown, is designed to be a retrofit add-on to an existing door, but it is contemplated that the lock 10 could be integrated into a new installation door and/or frame.

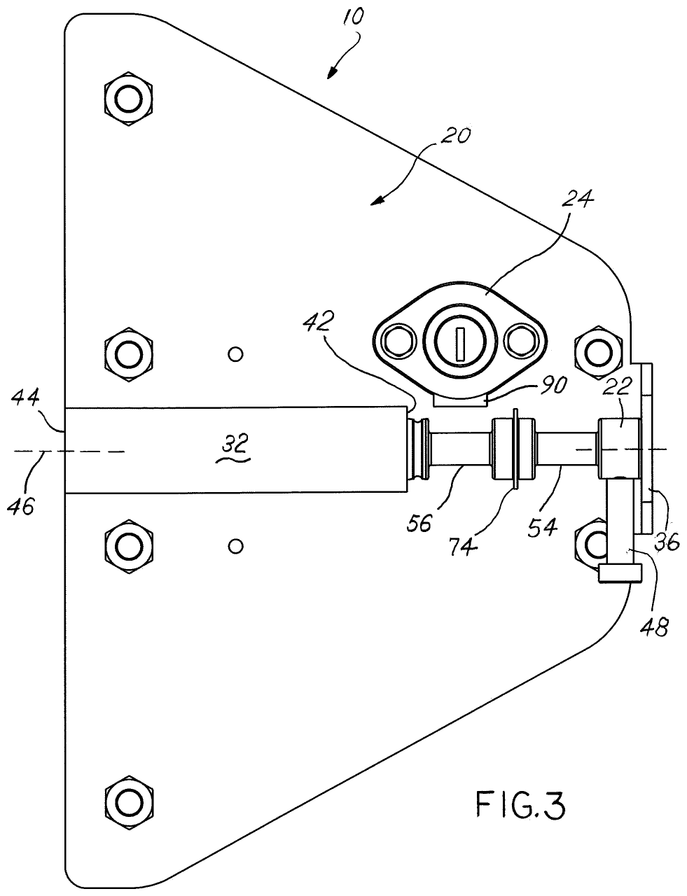

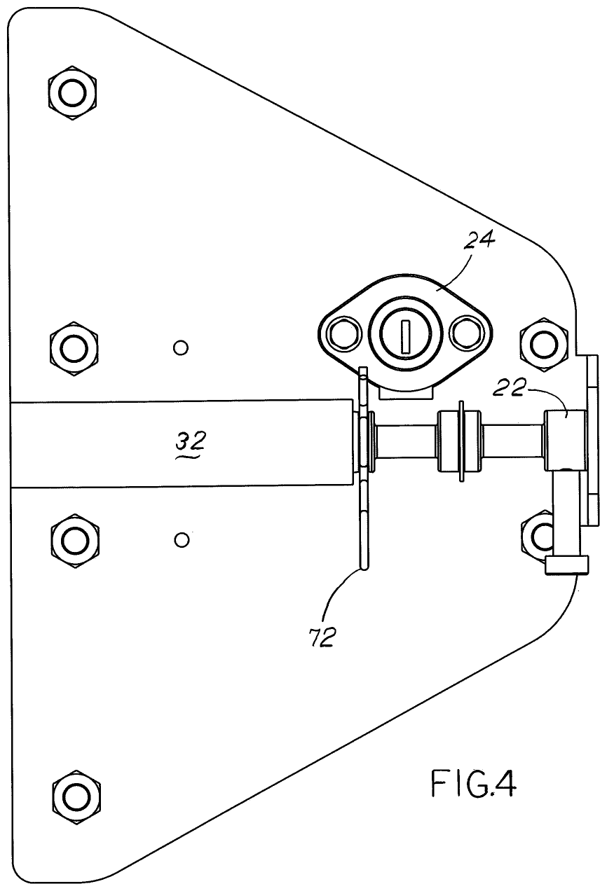

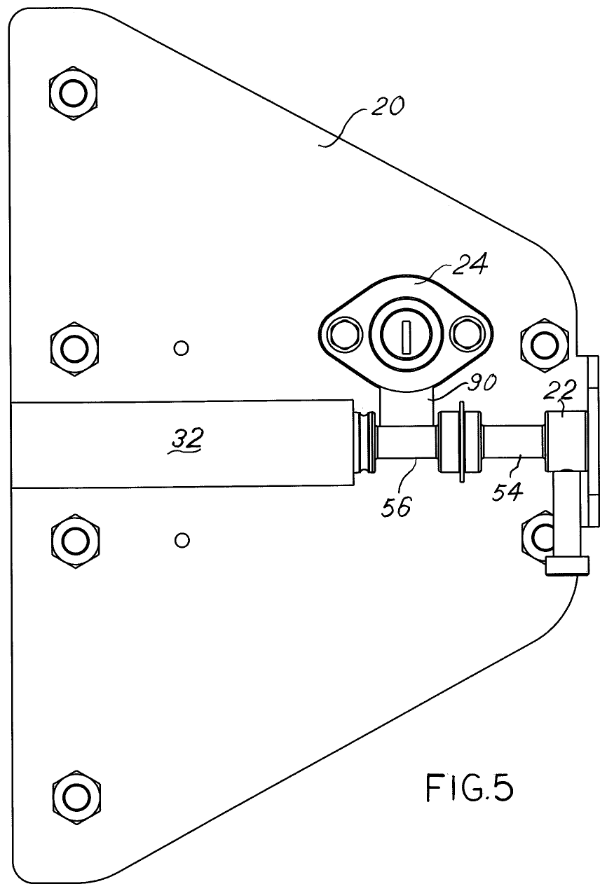

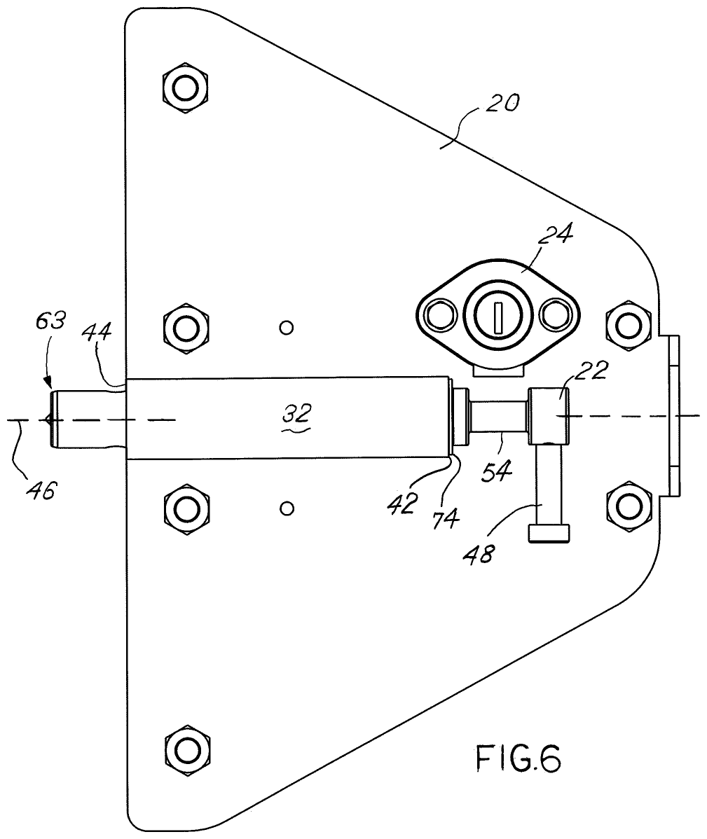

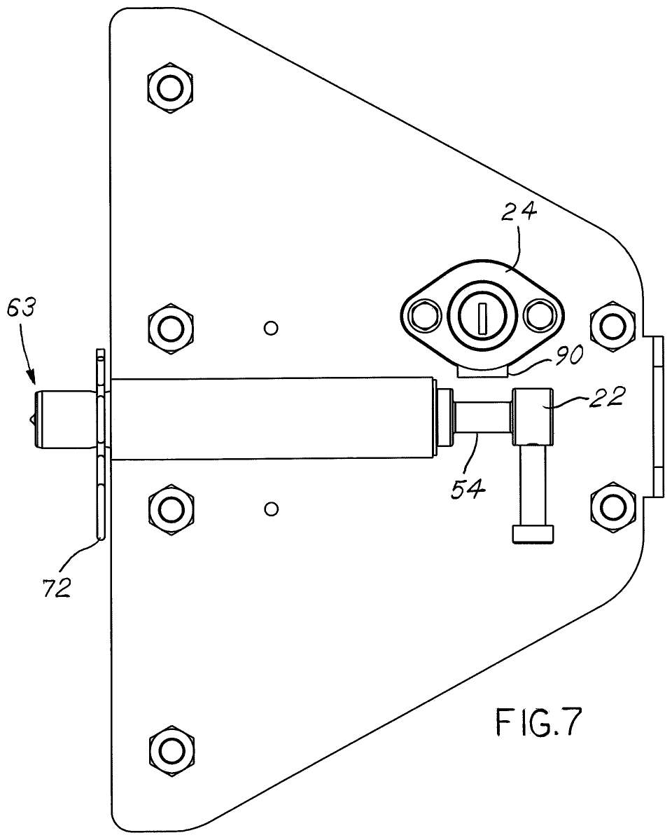

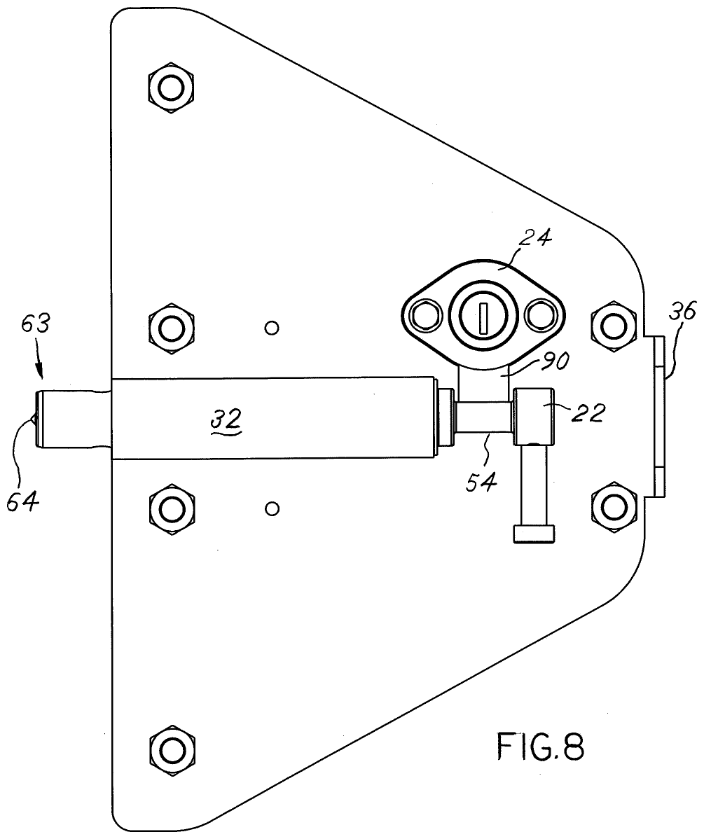

The lock 10 is shown in various states in FIGS. 3-8. The lock 10 has several main components, a mounting 20, a bolt 22, and a bolt lock 24. The bolt 22 is movable between an unlocked position as shown in FIGS. 3-5 and a locked position as shown in FIGS. 6-8. The bolt 22 may be freely movable as shown in FIGS. 3 and 6, held with a pin as shown in FIGS. 4 and 7, or locked with the bolt lock 24 as shown in FIGS. 5 and 8.

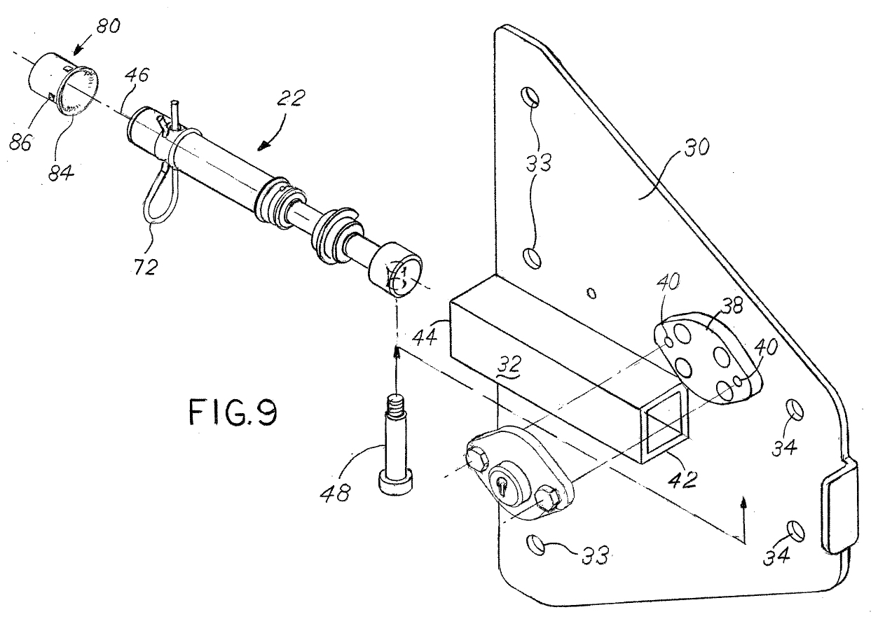

The mounting 20 is shown with further detail in FIG. 9 and has a plate 30, which is primarily a structural member that holds the components of the lock 10 in the correct position and allows for a simple method to attach the lock 10 to the door. The plate 30 has a series of mounting apertures 33, 34. The mounting apertures 33 are nearest the edge of the door when affixed thereto. The other mounting apertures 34 are located further away from the edge. The mounting apertures 33, 34 will receive carriage bolts (not shown) that extend through the thickness of the door for a secure connection. When the carriage bolts are tightened, the mounting 20 is held tightly to the surface of the door. The plate 30 has a bolt tube 32 that receives the bolt 22 and allows it to move between the locked and unlocked positions. As shown, the bolt tube 32 is square, but other shapes are contemplated, including separate tubes or straps that allow the bolt 22 to move between the locked and unlocked positions. The bolt tube 32 has terminal ends 42, 44 that are used as reference surfaces for the bolt 22. The plate 30 includes a backstop 36 and a bolt lock mount 38. The backstop 36 and bolt lock mount 38 may be separate, integral, or features formed into the plate 30 through forming, bending, welding, or another method. The lock mount 38 will commonly have threaded apertures 40 that will receive fasteners to hold the bolt lock 24 to the mounting 20. The backstop 36 as shown in FIG. 9 is a bent metal tab located on the plate 30, while it is contemplated that an alternative backstop is a welded block.

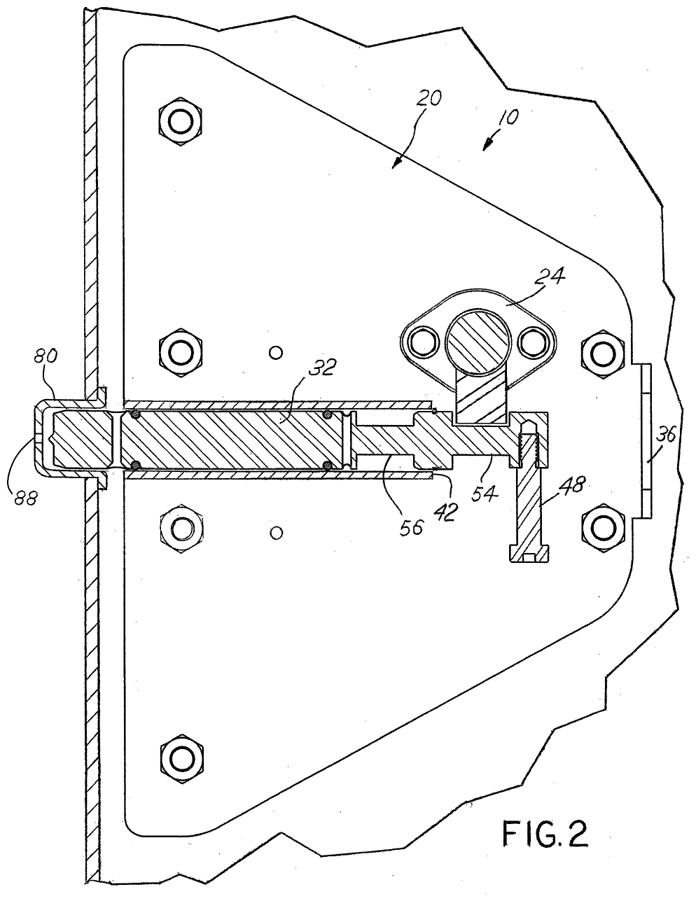

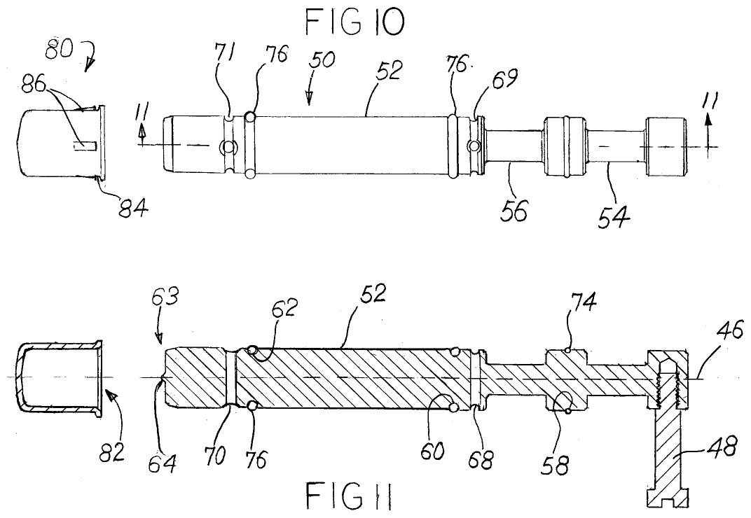

The bolt 22 is shown in detail in FIGS. 9-11. As assembled to the lock 10, the bolt 22 resides in the bolt tube 32 and slides along its central axis 46. The bolt 22 has a handle 48 that allows the user to easily grasp and slide the bolt between the locked and unlocked position. The bolt 22 has a main shaft portion 50 with an outer diameter surface 52. Several grooves are cut or otherwise formed into the main shaft portion 50. There is a lock groove 54, an unlock groove 56, an e-clip groove 58, and two anti-rattle grooves 60, 62. The shaft portion 50 includes transverse holes 68, 70 that are designed to receive a clip 72. The transverse holes 68, 70 may have a corresponding groove 69, 71 that assists alignment of the clip 72. The clip 72, as shown, is a cotter pin or hitch pin clip, but other easily removable clips are contemplated. The e-clip groove 58 receives an e-clip 74. Other semi-permanent clips are contemplated, such as c-clips, ridges, snap rings, or another feature that would contact the terminal end 42 to constrain the bolt 22 from excessive axial movement in the locked position. It is contemplated that instead of a groove 58, there could be a transverse hole that would receive a roll pin, bolt, screw or other feature that contacts the terminal end 42. The anti-rattle grooves 60, 62 each hold an O-ring 76. The O-rings 76 provide a resilient component that contacts the inside of the bolt tube 32 and separates the main shaft portion 50 from directly contacting the bolt tube 32. Without the O-rings 76, the bolt 22 would rattle inside the bolt tube 32, along with the bolt inadvertently moving between the locked and unlocked positions. The O-rings 76 provide some resistance for rotating and sliding of the bolt 22 due to the biased contact they have with the inside of the bolt tube 32. The bolt 22 is shown with an optional center punch 64 on a terminal end 63 that protrudes from the terminal end of the main shaft portion. The center punch 64 provides installation assistance when mounting a bolt receiver 80. The bolt receiver 80, which is also known as a thimble strike, has an aperture 82 that receives the end of the main shaft portion 50 when locked. As with common deadbolts, installation requires drilling or some form of alignment for the bolt receiver 80. When struck against the door frame, plate, or bolt receiver, the center punch 64 provides a mark to align a drill. After drilling, the bolt receiver 80 is pressed into the door frame 14, as shown in FIG. 2. The bolt receiver 80 can also be secured to the door frame 14 through a hole 88 that can receive a screw or other fastener. The bolt receiver 80 has a flange 84 that prevents the receiver from being pushed too far into the frame 14, along with retainers 86 that prevent the receiver from being pulled out inadvertently. The retainers 86 are bent tabs that extend outwardly to catch on the inside of the door frame 14. Door frames in commercial, governmental, and institutional buildings are commonly metal to provide strength and fire protection. The door frame 14 shown in FIG. 2 is a metal style, but it is contemplated that wooden or other door frame materials work with the bolt receiver 80. In the event the door frame is another material, the retainers 86 would still prevent the inadvertent removal of the bolt receiver 80 by digging into the door frame material.

The lock 24 is movable between a retracted position, shown in FIGS. 3, 4, 6, and 7 and an extended position, shown in FIGS. 5 and 8. In the retracted position, the tab 90 is clear of the lock and unlock groove 54, 56. The tab 90 also would need to be retractable enough to be clear of the e-clip 74 when the bolt 22 moves between the locked and unlocked positions. The lock 24 is affixed to the mount 20 and operates with a key (not shown). The key can be removed from the lock in the extended and retracted position. The tab 90 and grooves 54, 56 are complimentary. In other words, the grooves 54, 56 are wide enough to accept the tab 90 to axially constrain the bolt 22 when the tab 90 is located in one of the grooves 54, 56.

It is understood that while certain aspects of the disclosed subject matter have been shown and described, the disclosed subject matter is not limited thereto and encompasses various other embodiments and aspects. No specific limitation with respect to the specific embodiments disclosed herein is intended or should be inferred. Modifications may be made to the disclosed subject matter as set forth in the following claims.

What is claimed is:

1. A retrofit locking system for an existing door, said door connected to a door frame, said door moveable between an opened and a closed position, when said door is in said closed position, said door is latched to said door frame comprising:
a mount for being affixed to said door with fasteners extending through a plurality of apertures in said door and said mount, said mount having a bolt tube affixed thereto;
a bolt having a central axis and located inside said bolt tube, said bolt is slidable between an extended and retracted position on said central axis, wherein said extended position is defined by a terminal end of said bolt extending from a terminal end of said bolt tube and said retracted position is defined by said terminal end located inside said bolt tube, said bolt having an unlock groove and a lock groove, said bolt having a transverse hole for receiving a cotter pin;
a lock affixed to said mount, said lock having a tab with an extended position and a retracted position, when said tab is in said extended position, said tab is located in said unlock or said lock groove;
a bolt receiver for being affixed to said door frame and aligned with said central axis when said door is latched; and
said bolt moveable between said extended and retracted position when said door is in said opened and said closed position, when said bolt is moved to said extended position and said door is in said opened position, said bolt prevents said door from latching to said door frame, when said bolt is moved to said extended position and said door is in said closed position, said door is affixed to said frame, said bolt lockable in said extended position and said retracted position when said tab is in one of said grooves.

2. The locking system of claim 1, wherein said bolt has anti-rattle grooves, said anti-rattle grooves each carrying an o-ring that contacts an inside surface of said bolt tube.

3. The locking system of claim 1, wherein said terminal end of said bolt has a center punch extending therefrom and located on said central axis, said center punch for marking said door frame to position said bolt receiver.

4. The locking system of claim 1, wherein said bolt receiver has retaining tabs extending outwardly therefrom to retain said bolt receiver in said door frame.

5. The locking system of claim 1, further comprising a cotter pin, when said cotter pin is located in said transverse hole, said bolt is constrained from movement along said central axis.

6. The locking system of claim 1, wherein said mount has a backstop, said bolt is captured in said bolt tube by said backstop and an e-clip located on said bolt.

7. A retrofit locking system for an existing door, said door connected to a door frame, said door moveable between an opened and a closed position, when said door is in said closed position, said door is latched to said door frame comprising:
a mount for being affixed to said door with fasteners extending through a plurality of apertures in said door and said mount, said mount having a bolt tube affixed thereto;
a bolt having a central axis and located inside said bolt tube, said bolt is slidable between an extended and retracted position on said central axis, wherein said extended position is defined by a terminal end of said bolt extending from a terminal end of said bolt tube and said retracted position is defined by said terminal end located inside said bolt tube, said bolt having a transverse hole for receiving a cotter pin;
said terminal end of said bolt has a center punch extending therefrom and located on said central axis, said center punch for marking said door frame to position said bolt receiver;
a bolt receiver for being affixed to said door frame and aligned with said central axis when said door is latched; and
said bolt moveable between said extended and retracted position when said door is in said opened and said closed position, when said bolt is moved to said extended position and said door is in said opened position, said bolt prevents said door from latching to said door frame, when said bolt is moved to said extended position and said door is in said closed position, said door is affixed to said frame, said bolt lockable in said extended position and said retracted position when said tab is in one of said grooves.

8. The locking system of claim 7, wherein said bolt has anti-rattle grooves, said anti-rattle grooves each carrying an o-ring that contacts an inside surface of said bolt tube.

9. The locking system of claim 7, wherein said bolt receiver has retaining tabs extending outwardly therefrom to retain said bolt receiver in said door frame.

10. The locking system of claim 7, further comprising a cotter pin, when said cotter pin is located in said transverse hole, said bolt is constrained from movement along said central axis.

11. The locking system of claim 7, further comprising a lock affixed to said mount, said lock having a tab with an extended position and a retracted position, said bolt having an unlock groove and a lock groove, when said tab is in said extended position, said tab is located in said unlock or said lock groove.

12. The locking system of claim 7, wherein said mount has a backstop, said bolt is captured in said bolt tube by said backstop and an e-clip located on said bolt.

13. A locking system for a door, said door connected to a door frame, said door moveable between an opened and a closed position, when said door is in said closed position, said door is latched to said door frame comprising:
a mount for being affixed to said door with fasteners extending through a plurality of apertures in said door and said mount, said mount having a bolt tube affixed thereto;
a bolt having a central axis and located inside said bolt tube, said bolt is slidable between an extended and retracted position on said central axis, wherein said extended position is defined by a terminal end of said bolt extending from a terminal end of said bolt tube and said retracted position is defined by said terminal end located inside said bolt tube, said bolt having a transverse hole for receiving a cotter pin;
a bolt receiver for being affixed to said door frame and aligned with said central axis when said door is latched;
said terminal end of said bolt has a center punch extending therefrom and located on said central axis, said center punch for marking said door frame to position said bolt receiver; and
said bolt moveable between said extended and retracted position when said door is in said opened and said closed position, when said bolt is moved to said extended position and said door is in said opened position, said bolt prevents said door from latching to said door frame, when said bolt is moved to said extended position and said door is in said closed position, said door is affixed to said frame, said bolt lockable in said extended position and said retracted position.

14. The locking system of claim 13, wherein said bolt has anti-rattle grooves, said anti-rattle grooves each carrying an o-ring that contacts an inside surface of said bolt tube.

15. The locking system of claim 13, wherein said bolt receiver has retaining tabs extending outwardly therefrom to retain said bolt receiver in said door frame.

16. The locking system of claim 13, further comprising a cotter pin, when said cotter pin is located in said transverse hole, said bolt is constrained from movement along said central axis.

17. The locking system of claim 13, further comprising a lock affixed to said mount, said lock having a tab with an extended position and a retracted position, said bolt having an unlock groove and a lock groove, when said tab is in said extended position, said tab is located in said unlock or said lock groove.

18. The locking system of claim 13, wherein said mount has a backstop, said bolt is captured in said bolt tube by said backstop and an e-clip located on said bolt.
